(19) United States
(12) Patent Application Publication
(10) Pub. No.: US 2024/0257211 A1
(43) Pub. Date: Aug. 1, 2024

(54) SYSTEMS AND METHODS FOR ANALYZING AND DISPLAYING PRODUCTS

(71) Applicant: Walmart Apollo, LLC, Bentonville, AR (US)

(72) Inventors: Sonal Bathe, Sunnyvale, CA (US); Rahul Sridhar, Santa Clara, CA (US); Sinduja Subramaniam, San Jose, CA (US); Evren Korpeoglu, San Jose, CA (US); Kannan Achan, Saratoga, CA (US)

(73) Assignee: Walmart Apollo, LLC, Bentonville, AR (US)

(21) Appl. No.: 18/103,236

(22) Filed: Jan. 30, 2023

(51) Int. Cl. G06Q 30/0601; G06Q 30/0202

(52) U.S. Cl. CPC G06Q 30/0631; G06Q 30/0202; G06Q 30/0641

(57) ABSTRACT

Systems and methods including one or more processors and one or more non-transitory computer readable media storing computing instructions that, when executed on the one or more processors, cause the one or more processors to perform: receiving historical marketplace information for a user in a marketplace corresponding to products previously purchased by the user; processing the products to group the products into one or more product-type clusters; analyzing the one or more product-type clusters to determine respective inter-purchase interval (IPI) likelihood scores for each product in each of the one or more product-type clusters; identifying one or more candidate products from the one or more product-type clusters that have respective IPI likelihood scores that satisfy one or more thresholds; determining a respective time and a respective duration for a respective re-purchase notification for the user based on the respective IPI likelihood score for each of the one or more candidate products; ranking the one or more candidate products based on the respective IPI likelihood scores for the one or more candidate products; and transmitting a re-purchase notification to the user via a graphical user interface (GUI) that includes at least a subset of the one or more candidate products, the GUI including a first section that includes a first portion of the at least the subset of the one or more candidate products and a second section that includes a second portion of the at least the subset of the one or more candidate products. Other embodiments are disclosed.

### TECHNICAL FIELD

This disclosure relates generally to computing system management, and more particularly to systems and methods for analyzing and displaying products.

### BACKGROUND

Online orders often include items that are frequently re-ordered. In many orders, more than half of the items are re-ordered items. Re-ordering such items generally involves browsing through multiple pages on a website to locate and add such items to an online order, which can be time-consuming. Additionally, users may forget some of the items that they would prefer to re-order.

### BRIEF DESCRIPTION OF THE DRAWINGS

To facilitate further description of the embodiments, the following drawings are provided in which:

FIG. 1 illustrates a front elevational view of a computer system that is suitable for implementing various embodiments of the systems disclosed in FIG. 3;

FIG. 2 illustrates a representative block diagram of an example of the elements included in the circuit boards inside a chassis of the computer system of FIG. 1;

FIG. 3 illustrates a representative block diagram of a system, according to an embodiment;

FIG. 4 illustrates a flowchart for a method, according to certain embodiments;

FIG. 5 illustrates an exemplary user interface, according to certain embodiments;

FIG. 6 illustrates an exemplary user interface, according to certain embodiments; and

FIG. 7 illustrates an exemplary user interface, according to certain embodiments.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

A number of embodiments can include a system. The system can include one or more processors and one or more non-transitory computer-readable storage devices storing computing instructions. The computing instructions can be configured to run on the one or more processors and cause the one or more processors to perform: receiving historical marketplace information for a user in a marketplace corresponding to products previously purchased by the user; processing the products to group the products into one or more product-type clusters; analyzing the one or more product-type clusters to determine respective inter-purchase interval (IPI) likelihood scores for each product in each of the one or more product-type clusters; identifying one or more candidate products from the one or more product-type clusters that have respective IPI likelihood scores that satisfy one or more thresholds; determining a respective time and a respective duration for a respective re-purchase notification for the user based on the respective IPI likelihood score for each of the one or more candidate products; ranking the one or more candidate products based on the respective IPI likelihood scores for the one or more candidate products; and transmitting a re-purchase notification to the user via a graphical user interface (GUI) that includes at least a subset of the one or more candidate products, the GUI including a first section that includes a first portion of the at least the subset of the one or more candidate products and a second section that includes a second portion of the at least the subset of the one or more candidate products.

Various embodiments include a method. The method can be implemented via execution of computing instructions configured to run at one or more processors and configured to be stored at non-transitory computer-readable media. The method can comprise receiving historical marketplace information for a user in a marketplace corresponding to products previously purchased by the user; processing the products to group the products into one or more product-type clusters; analyzing the one or more product-type clusters to determine respective inter-purchase interval (IPI) likelihood scores for each product in each of the one or more product-type clusters; identifying one or more candidate products from the one or more product-type clusters that have respective IPI likelihood scores that satisfy one or more thresholds; determining a respective time and a respective duration for a respective re-purchase notification for the user based on the respective IPI likelihood score for each of the one or more candidate products; ranking the one or more candidate products based on the respective IPI likelihood scores for the one or more candidate products; and transmitting a re-purchase notification to the user via a graphical user interface (GUI) that includes at least a subset of the one or more candidate products, the GUI including a first section that includes a first portion of the at least the subset of the one or more candidate products and a second section that includes a second portion of the at least the subset of the one or more candidate products.

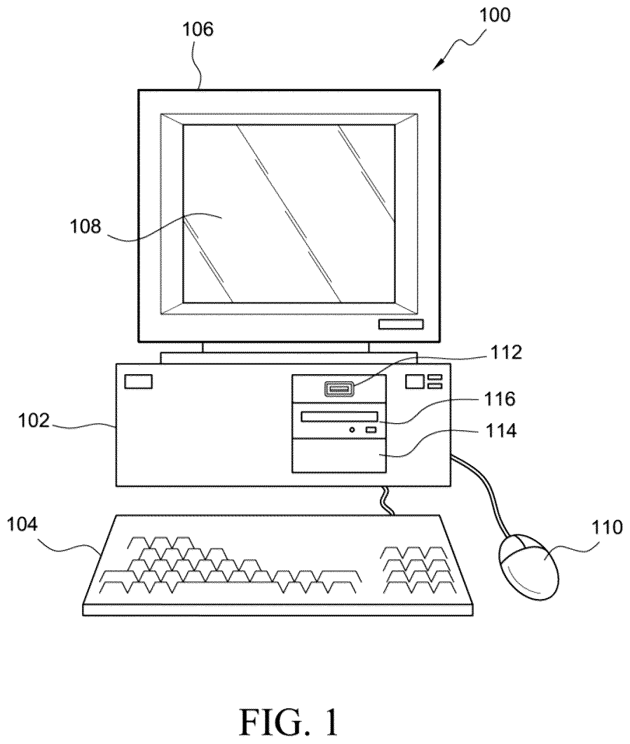

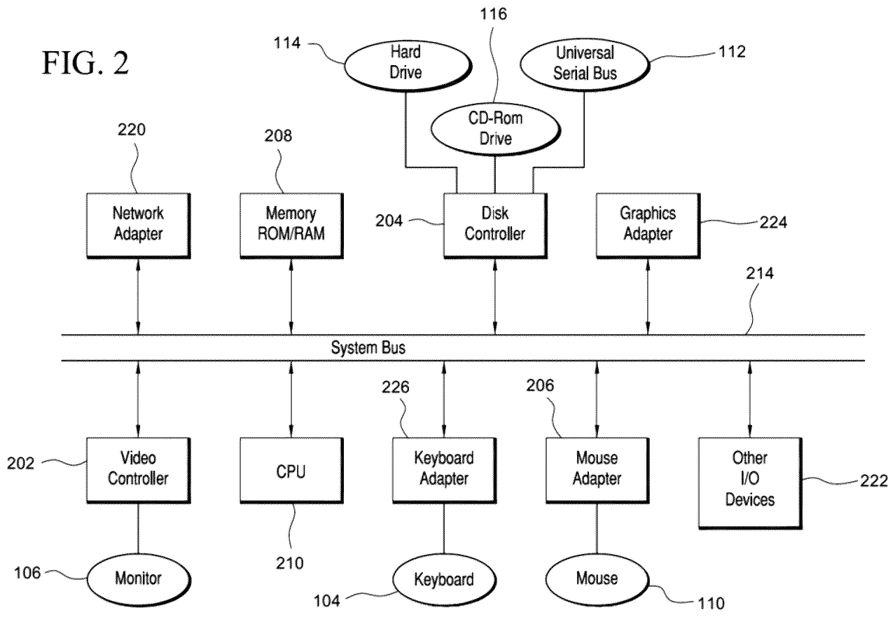

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the memory storage modules described herein. As an example, a different or separate one of a chassis 102 (and its internal components) can be suitable for implementing part or all of one or more embodiments of the techniques, methods, and/or systems described herein. Furthermore, one or more elements of computer system 100 (e.g., a monitor 106, a keyboard 104, and/or a mouse 110, etc.) also can be appropriate for implementing part or all of one or more embodiments of the techniques, methods, and/or systems described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to a memory storage unit 208, where memory storage unit 208 can comprise (i) non-volatile memory, such as, for example, read only memory (ROM) and/or (ii) volatile memory, such as, for example, random access memory (RAM). The non-volatile memory can be removable and/or non-removable non-volatile memory. Meanwhile, RAM can include dynamic RAM (DRAM), static RAM (SRAM), etc. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In these or other embodiments, memory storage unit 208 can comprise (i) non-transitory memory and/or (ii) transitory memory.

In many embodiments, all or a portion of memory storage unit 208 can be referred to as memory storage module(s) and/or memory storage device(s). In various examples, portions of the memory storage module(s) of the various embodiments disclosed herein (e.g., portions of the non-volatile memory storage module(s)) can be encoded with a boot code sequence suitable for restoring computer system 100 (FIG. 1) to a functional state after a system reset. In addition, portions of the memory storage module(s) of the various embodiments disclosed herein (e.g., portions of the non-volatile memory storage module(s)) can comprise microcode such as a Basic Input-Output System (BIOS) operable with computer system 100 (FIG. 1). In the same or different examples, portions of the memory storage module(s) of the various embodiments disclosed herein (e.g., portions of the non-volatile memory storage module(s)) can comprise an operating system, which can be a software program that manages the hardware and software resources of a computer and/or a computer network. The BIOS can initialize and test components of computer system 100 (FIG. 1) and load the operating system. Meanwhile, the operating system can perform basic tasks such as, for example, controlling and allocating memory, prioritizing the processing of instructions, controlling input and output devices, facilitating networking, and managing files. Exemplary operating systems can comprise one of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processing modules of the various embodiments disclosed herein can comprise CPU 210.

Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs. In many embodiments, an application specific integrated circuit (ASIC) can comprise one or more processors or microprocessors and/or memory blocks or memory storage.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to keyboard 104 (FIGS. 1-2) and mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM drive 116 (FIGS. 1-2). In other embodiments, distinct units can be used to control each of these devices separately.

Network adapter 220 can be suitable to connect computer system 100 (FIG. 1) to a computer network by wired communication (e.g., a wired network adapter) and/or wireless communication (e.g., a wireless network adapter). In some embodiments, network adapter 220 can be plugged or coupled to an expansion port (not shown) in computer system 100 (FIG. 1). In other embodiments, network adapter 220 can be built into computer system 100 (FIG. 1). For example, network adapter 220 can be built into computer system 100 (FIG. 1) by being integrated into the motherboard chipset (not shown), or implemented via one or more dedicated communication chips (not shown), connected through a PCI (peripheral component interconnector) or a PCI express bus of computer system 100 (FIG. 1) or USB port 112 (FIG. 1).

Returning now to FIG. 1, although many other components of computer system 100 are not shown, such components and their interconnection are well known to those of ordinary skill in the art. Accordingly, further details concerning the construction and composition of computer system 100 and the circuit boards inside chassis 102 are not discussed herein.

Meanwhile, when computer system 100 is running, program instructions (e.g., computer instructions) stored on one or more of the memory storage module(s) of the various embodiments disclosed herein can be executed by CPU 210 (FIG. 2). At least a portion of the program instructions, stored on these devices, can be suitable for carrying out at least part of the techniques and methods described herein.

Further, although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile electronic device, such as a smartphone. In certain additional embodiments, computer system 100 may comprise an embedded system.

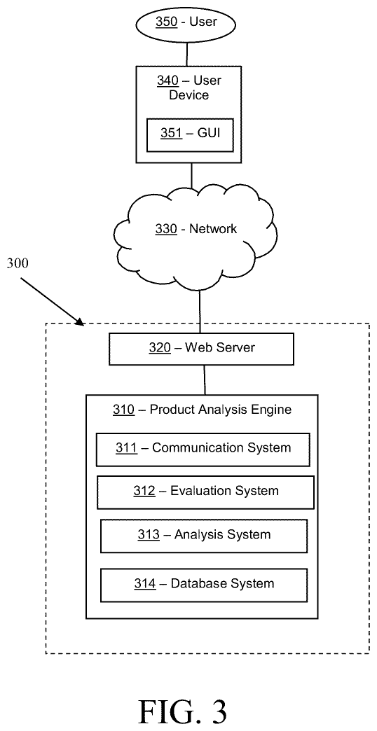

Turning ahead in the drawings, FIG. 3 illustrates a block diagram of a system 300 that can be employed for analyzing and displaying products, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. In some embodiments, system 300 can include a product analysis engine 310 and/or web server 320.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Product analysis engine 310 and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host product analysis engine 310 and/or web server 320. Additional details regarding product analysis engine 310 and/or web server 320 are described herein.

In some embodiments, web server 320 can be in data communication through a network 330 with one or more user devices, such as a user device 340, which also can be part of system 300 in various embodiments. User device 340 can be part of system 300 or external to system 300. Network 330 can be the Internet or another suitable network. In some embodiments, user device 340 can be used by users, such as a user 350. In many embodiments, web server 320 can host one or more websites and/or mobile application servers. For example, web server 320 can host a website, or provide a server that interfaces with an application (e.g., a mobile application), on user device 340, which can allow users (e.g., 350) to interact with infrastructure components in an IT environment, in addition to other suitable activities. In a number of embodiments, web server 320 can interface with product analysis engine 310 when a user (e.g., 350) is viewing infrastructure components in order to assist with the analysis of the infrastructure components.

In some embodiments, an internal network that is not open to the public can be used for communications between product analysis engine 310 and web server 320 within system 300. Accordingly, in some embodiments, product analysis engine 310 (and/or the software used by such systems) can refer to a back end of system 300 operated by an operator and/or administrator of system 300, and web server 320 (and/or the software used by such systems) can refer to a front end of system 300, as is can be accessed and/or used by one or more users, such as user 350, using user device 340. In these or other embodiments, the operator and/or administrator of system 300 can manage system 300, the processor(s) of system 300, and/or the memory storage unit(s) of system 300 using the input device(s) and/or display device(s) of system 300.

In certain embodiments, the user devices (e.g., user device 340) can be desktop computers, laptop computers, mobile devices, and/or other endpoint devices used by one or more users (e.g., user 350). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ product or a similar product by Google Inc. of Menlo Park, California, United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, New York, United States of America. In other specific examples, a head mountable wearable user computer device can comprise the Virtual Retinal Display™ product, or similar product by the University of Washington of Seattle, Washington, United States of America. Meanwhile, in further specific examples, a limb mountable wearable user computer device can comprise the iWatch™ product, or similar product by Apple Inc. of Cupertino, California, United States of America, the Galaxy Gear or similar product of Samsung Group of Samsung Town, Seoul, South Korea, the Moto 360 product or similar product of Motorola of Schaumburg, Illinois, United States of America, and/or the Zip™ product, One™ product, Flex™ product, Charge™ product, Surge™ product, or similar product by Fitbit Inc. of San Francisco, California, United States of America.

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Android™ operating system developed by the Open Handset Alliance, or (iv) the Windows Mobile™ operating system by Microsoft Corp. of Redmond, Washington, United States of America.

In many embodiments, product analysis engine 310 and/or web server 320 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to product analysis engine 310 and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of product analysis engine 310 and/or web server 320. In a similar manner, the processors and/or the non-transitory computer-readable media can be local and/or remote to each other.

Meanwhile, in many embodiments, product analysis engine 310 and/or web server 320 also can be configured to communicate with one or more databases, such as a database system 314. The one or more databases can include historical marketplace information, user activity information, and/or machine learning training data, for example, among other data as described herein. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, product analysis engine 310, web server 320, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, product analysis engine 310 can include a communication system 311, an evaluation system 312, an analysis system 313, and/or database system 314. In many embodiments, the systems of product analysis engine 310 can be modules of computing instructions (e.g., software modules) stored at non-transitory computer readable media that operate on one or more processors. In other embodiments, the systems of product analysis engine 310 can be implemented in hardware. Product analysis engine 310 and/or web server 320 each can be a computer system, such as computer system 100 (FIG. 1), as described above, and can be a single computer, a single server, or a cluster or collection of computers or servers, or a cloud of computers or servers. In another embodiment, a single computer system can host product analysis engine 310 and/or web server 320. Additional details regarding product analysis engine 310 and the components thereof are described herein.

In many embodiments, user device 340 can comprise graphical user interface (“GUI”) 351. In the same or different embodiments, GUI 351 can be part of and/or displayed by user computer 340, which also can be part of system 300. In some embodiments, GUI 351 can comprise text and/or graphics (image) based user interfaces. In the same or different embodiments, GUI 351 can comprise a heads up display (“HUD”). When GUI 351 comprises a HUD, GUI 351 can be projected onto a medium (e.g., glass, plastic, etc.), displayed in midair as a hologram, or displayed on a display (e.g., monitor 106 (FIG. 1)). In various embodiments, GUI 351 can be color, black and white, and/or greyscale. In many embodiments, GUI 351 can comprise an application running on a computer system, such as computer system 100 (FIG. 1), user computers 340. In the same or different embodiments, GUI 351 can comprise a website accessed through internet 320. In some embodiments, GUI 351 can comprise an eCommerce website. In these or other embodiments, GUI 351 can comprise an administrative (e.g., back end) GUI allowing an administrator to modify and/or change one or more settings in system 300. In the same or different embodiments, GUI 351 can be displayed as or on a virtual reality (VR) and/or augmented reality (AR) system or display. In some embodiments, an interaction with a GUI can comprise a click, a look, a selection, a grab, a view, a purchase, a bid, a swipe, a pinch, a reverse pinch, etc.

In some embodiments, web server 320 can be in data communication through network (e.g., Internet) 330 with user computers (e.g., 340). In certain embodiments, user computers 340 can be desktop computers, laptop computers, smart phones, tablet devices, and/or other endpoint devices. Web server 320 can host one or more websites. For example, web server 320 can host an eCommerce website that allows users to browse and/or search for products, to add products to an electronic shopping cart, and/or to purchase products, in addition to other suitable activities.

In many embodiments, product analysis engine 310, and/or web server 320 can each comprise one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to the processing module(s) and/or the memory storage module(s) of product analysis engine 310, and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In some embodiments, the KVM switch also can be part of product analysis engine 310, and/or web server 320. In a similar manner, the processing module(s) and the memory storage module(s) can be local and/or remote to each other.

In many embodiments, product analysis engine 310, and/or web server 320 can be configured to communicate with one or more user computers 340. In some embodiments, user computers 340 also can be referred to as customer computers. In some embodiments, product analysis engine 310, and/or web server 320 can communicate or interface (e.g., interact) with one or more customer computers (such as user computers 340) through a network or internet 330. Internet 330 can be an intranet that is not open to the public. In further embodiments, Internet 330 can be a mesh network of individual systems. Accordingly, in many embodiments, product analysis engine 310, and/or web server 320 (and/or the software used by such systems) can refer to a back end of system 300 operated by an operator and/or administrator of system 300, and user computers 340 (and/or the software used by such systems) can refer to a front end of system 300 used by one or more users 350, respectively. In some embodiments, users 350 can also be referred to as customers, in which case, user computers 340 can be referred to as customer computers. In these or other embodiments, the operator and/or administrator of system 300 can manage system 300, the processing module(s) of system 300, and/or the memory storage module(s) of system 300 using the input device(s) and/or display device(s) of system 300.

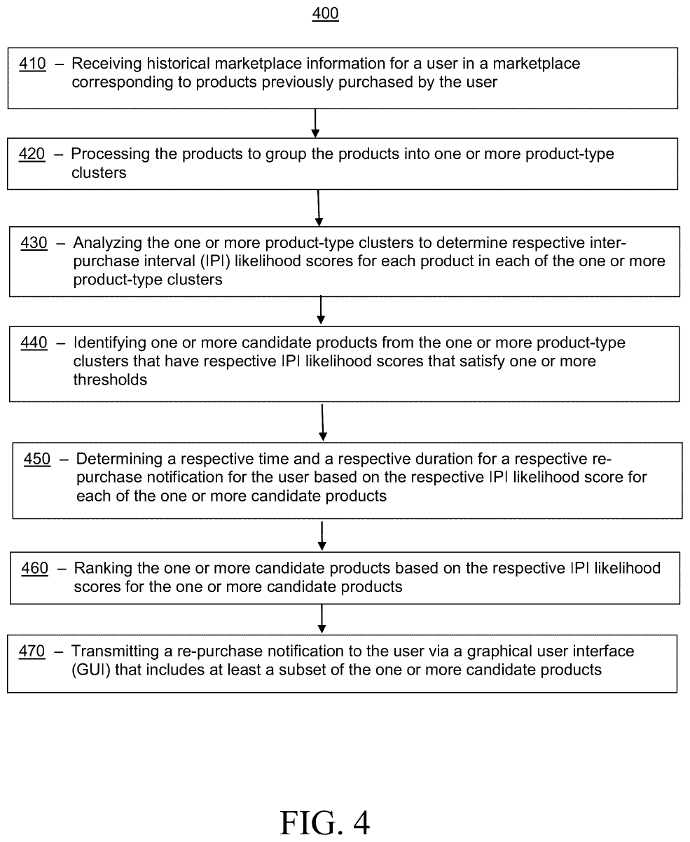

Turning ahead in the drawings, FIG. 4 illustrates a flow chart for a method 400, according to an embodiment. Method 400 is merely exemplary and is not limited to the embodiments presented herein. Method 400 can be employed in many different embodiments or examples not specifically depicted or described herein. In some embodiments, the activities of method 400 can be performed in the order presented. In other embodiments, the activities of method 400 can be performed in any suitable order. In still other embodiments, one or more of the activities of method 400 can be combined or skipped. In many embodiments, system 300 (FIG. 3) can be suitable to perform method 400 and/or one or more of the activities of method 400. In these or other embodiments, one or more of the activities of method 400 can be implemented as one or more computer instructions configured to run at one or more processing modules and configured to be stored at one or more non-transitory memory storage modules. Such non-transitory memory storage modules can be part of a computer system such as product analysis engine 310, web server 320, and/or user device 340 (FIG. 3). The processing module(s) can be similar or identical to the processing module(s) described above with respect to computer system 100 (FIG. 1).

In many embodiments, method 400 can comprise an activity 410 of receiving historical marketplace information for a user in a marketplace corresponding to products previously purchased by the user. In some embodiments, the historical marketplace information includes: item attributes of the products, global purchase patterns for the products that are not specific to the user, and product type metadata (e.g., location, availability, review score, etc.). In some embodiments, the historical marketplace information can include online transactions and in-store transactions made by the user and other users within a period of time occurring before the present time In many embodiments, the previous transactions can be stored in a database along with the times/dates of the orders of the online transactions and/or the in-store transactions. In some embodiments, a set of previous transactions of the user and/or other users can include online transactions and in-store transactions transacted within a set period of time. In many embodiments, the online transactions and the in-store transactions can be accumulated and/or saved within a database based on a period of time. In several embodiments, the set of items stored can be periodically updated to display relevant and/or current favorite items personal to the user. In various embodiments, the data accumulated and stored within the database can be used for current training data for machine learning approaches and/or determining a probability identifying the items to be ordered on specific times on specific days. For example, after each transaction on a given time of day, the set of items for each user can be automatically updated to add the transaction information to a database In some embodiments, one or more machine learning models can be utilized to perform the method of 400. In some embodiments, one or more machine learning models can include at least a logistic regression model, a decision tree model, a recurrent neural network model, and/or a multi-level learning model. In some embodiments, the output of the machine learning model can be used as a basis to determine probabilities items are likely to be re-ordered at the present time and/or at a particular time and/or day when the user will interact with the page, as described in more detail below.

In many embodiments, method 400 can comprise an activity 420 of processing the products to group the products into one or more product-type clusters. In some embodiments, the products can be clustered based on product features. For example, the product features can include an inter-order interval of a user, a basket size, a period of time since the last order, etc. Before clustering the products, activity 420 can, in various embodiments, compute representations of different product types (i.e., determine the product features to use for the clustering) based on predictive basket features. In some embodiments, activity 420 can include utilizing a k-means clustering algorithm to group the products into the one or more product-type clusters based on the product features. However, other clustering algorithms can be utilized such as, DBSCAN, Gaussian Mixture Models, Hierarchical Clustering, etc. to group the products into the one or more product-type clusters based on the product features. For example, the product type clusters can be associated with groceries, toiletries, electronics, perishables, clothing, household, personal care, pantry, baby, beauty, health, pet, etc. In one example, an inter-order interval of a user for a toilet paper can be once a month (e.g., the user purchases this item once a month) and another inter-order interval for paper towels can be once a month. In this example, the toilet paper and paper towels can be clustered into a toiletries product type. In another example, an inter-order interval of a user for blush can be once every three months (e.g., the user purchases this item once every three months) and another inter-order interval for concealer can be once every three months. In this example, the blush and concealer can be clustered into a beauty product type. In some embodiments, the clusters that have a long inter-purchase interval (IPI) that is greater than 40 days are utilized in further processing, and activity 420 can include removing the clusters of products that have an IPI less than 40 days. In other embodiments, the IPI is greater than 30 days or greater than 65 days. In many embodiments, method 400 can comprise an activity 430 of analyzing the one or more product-type clusters to determine respective inter-purchase interval (IPI) likelihood scores for each product in each of the one or more product-type clusters. In some embodiments, activity 430 can include analyzing a purchase history for the user for each product within the one or more product-type clusters. For example, activity 430 can include analyzing the purchase history of the user to determine which products have recently been purchased by the user. In some embodiments, activity 430 can include analyzing the purchase history of the user over a nine-month period, a twelve-month period, or an eighteen-month period to identify a respective interval between each purchase of each product within the one or more product-type clusters. For example, an interval can correspond to the frequency of purchases for a product. In some embodiments, the interval can be 25 days corresponding to the average amount of time between purchases of the product by the user. In some embodiments, activity 430 can include determining the respective IPI likelihood score for each product within the one or more product-type clusters based on: (a) the respective interval between each purchase of each such product by the user (i.e., a personalized IPI likelihood score) and (b) a global purchase interval from other users for other products in a same one of the one or more product-type clusters in which such product is located (i.e., a global level IPI likelihood score), which is particularly useful where the user does not have a purchase history for such product but where a global level IPI likelihood score is a lower confidence IPI than a personalized IPI likelihood score. For example, a user may purchase paper plates every month and an IPI repurchase likelihood score for “paper plates” is 30-days. Based on the IPI repurchase likelihood score, activity 430 can increase the probability that the product will be re-purchased based on the last time the user purchased the item. For example, the user can purchase “paper plates”, and activity 430 can reset the re-purchase probability to 0%. Each day activity 430 can increase the re-purchase probability. For example, on day 28, the re-purchase probability can be 98%. In some examples, when the user is purchasing the product for the first time, activity 430 can utilize a global IPI repurchase probability based on other users. For example, the global IPI repurchase probability for other users that purchase paper plates can be 35 days.

In many embodiments, method 400 can comprise an activity 440 of identifying one or more candidate products from the one or more product-type clusters that have respective IPI likelihood scores that satisfy one or more thresholds. For example, activity 440 can identify one or more products in the product type clusters that have an IPI likelihood score with a re-purchase probability above 90%. For example, the user can have a likelihood score of 30 days for “paper plates”, and currently have a re-purchase probability of 98% indicating that it has been 28 days since the user last purchased paper-plates. As such, paper-plates can be identified as a candidate product.

In many embodiments, method 400 can comprise an activity 450 of determining a respective time and a respective duration for a respective re-purchase notification for the user based on the respective IPI likelihood score for each of the one or more candidate products. In some embodiments, activity 450 can include identifying the respective IPI likelihood score for a particular one of the one or more candidate products that is above 25 days. For example, a product can have an IPI likelihood score of 30 days, and it has been 25 days since the product was last purchased by the user. In some embodiments, activity 450 can include determining the respective time for the particular one of the one or more candidate products to be during a first time period. For example, the first period of time can between 10:00 AM-12:00 PM, 5:00 PM-7:00 PM, or exactly 1:00 PM. Alternatively, the first period of time can be when the user is accessing a device (e.g., computer, mobile device, etc.). For example, activity 450 can indicate that the first time period is when the user first accesses a webpage associated with the marketplace. In some embodiments, activity 450 can include determining the respective duration for the respective re-purchase notification for the particular one of the one or more candidate products to be from day 25 to day 35 since the purchase by the user of the particular one of the one or more candidate products. For example, a product can have an IPI likelihood score of 30 days, and it has been 25 days since the product was last purchased by the user. The duration can be five days before day 30 and five days after day 30, in this example. However, the duration can be longer or shorter. In some embodiments, if the user purchases one of the candidate products, the IPI likelihood score can be reset to 0 for that candidate product, and the candidate product is removed from the notification. In some embodiments, in response to the user not interacting with the candidate products, activity 450 can include resetting the respective IPI likelihood score of the particular one of the one or more candidate products to 0. For example, the repurchase reminder notification for the candidate product can be removed from the reminder notification after the durations has ended.

In many embodiments, method 400 can comprise an activity 460 of ranking the one or more candidate products based on the respective IPI likelihood scores for the one or more candidate products. In some embodiments, ranking the one or more candidate products based on the respective IPI likelihood score for the one or more candidate products comprises identifying a group of the one or more candidate products with highest ones of the respective IPI likelihood scores. For example, activity 460 can include identifying the top 12 products with the highest IPI repurchase likelihood scores. In some embodiments, activity 460 can include transmitting the group of the one or more candidate products to a customer relationship management server.

In many embodiments, method 400 can comprise an activity 470 of transmitting a re-purchase notification to the user via a graphical user interface (GUI) that includes at least a subset of the one or more candidate products. In some embodiments, the GUI includes a first section that includes a first portion of the at least the subset of the one or more candidate products and a second section that includes a second portion of the at least the subset of the one or more candidate products.

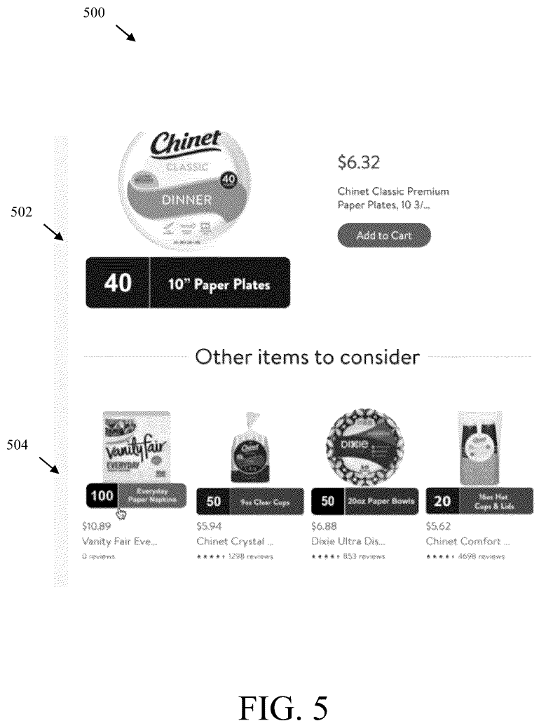

Turning briefly to FIG. 5, an exemplary user interface 500 is illustrated that can be displayed on the GUI 351 (FIG. 3). The user interface 500 of the illustrated embodiment includes a first section 502 that includes a first portion of the at least the subset of the one or more candidate products and a second section 504 that includes a second portion of the at least the subset of the one or more candidate products. For example, the first section 502 includes the candidate product with the highest likelihood score.

Returning to FIG. 4, activity 470 can include analyzing interaction data for the user with the GUI. In some embodiments, the interaction data can include clicks on products within the at least the subset of the one or more candidate products in the first section 502 (FIG. 5) and the second section 504 (FIG. 5). In some embodiments, activity 470 can include resetting the respective IPI likelihood scores for the one or more candidate products within the at least the subset of the one or more candidate products that include interaction data, and updating the GUI to include a second subset of the one or more candidate products with respective IPI likelihood scores that satisfies a threshold. For example, any products that are clicked on and repurchased are reset to an IPI repurchase likelihood score back to 0% and that purchase is sent back to update the purchase history for the user. In some embodiments, the one or more candidate products are re-ranked and the highest IPI likelihood score is positioned in the first section 502 (FIG. 5) of the user interface 500 (FIG. 5) and presented to the user in a subsequent notification.

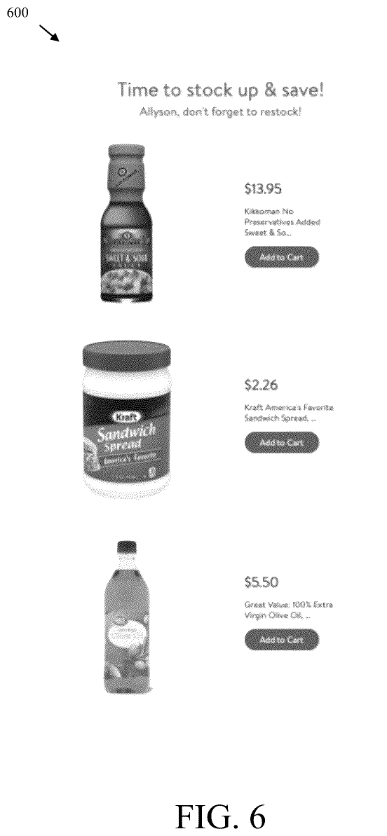

FIG. 6 illustrates another exemplary user interface 600 that can be used to present the candidate products to the user via the GUI 351 (FIG. 3).

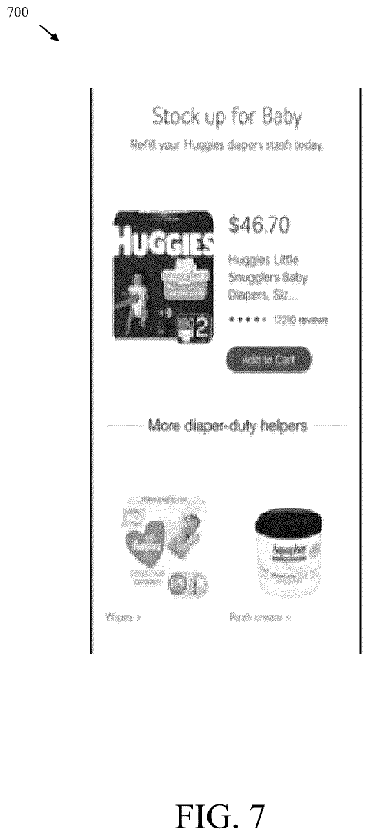

FIG. 7 illustrates another exemplary user interface 700 that can be used to present the candidate products to the user via the GUI 351 (FIG. 3). In some embodiments, the candidate products can be presented based on a particular product type. In the illustrated embodiment of FIG. 7, the user interface 700 is for baby products product type. In some embodiments, when a user interacts with a product in the user interface 500, 600, 700, the user is directed to the home page for that product (e.g., a landing page for the product in the marketplace).

Returning to FIG. 3, in several embodiments, communication system 311 can at least partially perform activity 410 (FIG. 4), and/or activity 470 (FIG. 4).

In several embodiments, evaluation system 312 can at least partially perform activity 420 (FIG. 4), and/or activity 430 (FIG. 4).

In a number of embodiments, analysis system 313 can at least partially perform activity 440 (FIG. 4), and/or activity 450 (FIG. 4), and/or activity 460 (FIG. 4).

In a number of embodiments, web server 320 can at least partially perform method 400.

In a number of embodiments, the techniques described herein can solve a technical problem that arises only within the realm of computer networks, as online orders do not exist outside the realm of computer networks. Generally, an average time a user spends online building a basket (e.g., virtual cart) to complete an online order can take thirty (30) to fifty (50) minutes due to the time-consuming task of selecting items on several different webpages and the computer resources used to navigate (e.g., search) several pages during a visit to a website, which could include, for example, navigating several hundred pages per visit. For example, if a user adds forty-five (45) items in a basket during an online session, that user can browse many more pages exceeding the actual number of items added to a basket. During each visit to a website for a single online session, testing has indicated that a user often selects more than half of the items previously ordered and/or regularly ordered in a basket. Previously ordered items can include items with expiration dates or consumption dates (e.g., fruit and other perishable food items, toiletries, cleaning products, and other such suitable item regularly ordered) that are personalized to that user. Additionally, a user often adds new items to a basket, which can involve further computer resources to continue browsing multiple webpages and selecting each new item to add to the order. By using a product analysis engine, a system can effectively predict a number of re-order items the user can select with a single option (e.g., click) which can beneficially result in a reduction in processor use and memory cache, among other things. The product analysis engine can improve the repurchase prediction for longer periodicity items (i.e., items that are purchased less frequently such as laundry detergents, cooking sauces, paper towels, over-the-counter medicines, etc.), which are more difficult to predict.

Moreover, the techniques described herein can solve a technical problem that cannot be solved outside the context of computer networks. Specifically, the techniques described herein cannot be used outside the context of computer networks, in view of a lack of data, and because the product analysis engine cannot be performed without a computer.

In many embodiments, the techniques described herein can provide a practical application and several technological improvements. In some embodiments, the techniques described herein can provide an automatic determination of a set of items by using a predictive model approach focusing on a propensity of a user to re-order based on at least a machine learning approach. These techniques described herein can provide a significant improvement over conventional approaches of subjectively searching for the same items to re-order that can expend a lot of time and computer resources, processors, and memory, to find each previously ordered item in a website (e.g., content catalog of webpages).

In a number of embodiments, the techniques described herein can advantageously provide a consistent user experience by adapting to a constantly changing website that adds new items to website inventory (e.g., online catalogs) of which less than half of the basket can be newly added inventory. Further the techniques described herein can advantageously enable real-time data processing and increase the capability to select a list of items to recommend to a user each time the user builds a basket in real-time. In various embodiments, the techniques also can advantageously provide a smoother reorder experience for customers, reduce the need for customers to remember when to restock previously purchased consumable merchandise that has a long inter-purchase interval, increase consumable merchandise purchases, and reinforce habitual repeat buying behavior.

In many embodiments, the techniques described herein can be used regularly (e.g, hourly, daily, etc.) at a scale that cannot be handled using manual techniques. For example, the system tracks every item ordered for each of a number of users that can result in a number of individual daily visits to the website that can exceed one hundred million, and the number of registered users to the website can exceed ten million.

Although systems and methods for product analysis have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-7 may be modified, and that the foregoing discussion of certain of these embodiments does not necessarily represent a complete description of all possible embodiments. For example, one or more of the procedures, processes, or activities of FIG. 4 may include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions that, when executed on the one or more processors, cause the one or more processors to perform:
receiving historical marketplace information for a user in a marketplace corresponding to products previously purchased by the user;
processing the products to group the products into one or more product-type clusters;
analyzing the one or more product-type clusters to determine respective inter-purchase interval (IPI) likelihood scores for each product in each of the one or more product-type clusters;
identifying one or more candidate products from the one or more product-type clusters that have respective IPI likelihood scores that satisfy one or more thresholds;
determining a respective time and a respective duration for a respective re-purchase notification for the user based on the respective IPI likelihood score for each of the one or more candidate products;
ranking the one or more candidate products based on the respective IPI likelihood scores for the one or more candidate products; and
transmitting a re-purchase notification to the user via a graphical user interface (GUI) that includes at least a subset of the one or more candidate products, the GUI including a first section that includes a first portion of the at least the subset of the one or more candidate products and a second section that includes a second portion of the at least the subset of the one or more candidate products.

2. The system of claim 1, wherein the historical marketplace information includes: item attributes of the products, global purchase patterns for the products that are not specific to the user, and product type metadata.

3. The system of claim 1, wherein the computing instructions, when executed on the one or more processors, further cause the one or more processors to perform before identifying the one or more candidate products, removing a product from the product-type clusters that does not satisfy a respective one of the one or more thresholds.

4. The system of claim 1, wherein processing the products comprises using a clustering model comprising a clustering algorithm to group the products into the one or more product-type clusters.

5. The system of claim 3, wherein each of the one or more thresholds is more than 30 days.

6. The system of claim 1, wherein analyzing the one or more product-type clusters to determine the respective IPI likelihood scores for each product in each of the one or more product-type clusters further comprises:
analyzing a purchase history for the user for each product within the one or more product-type clusters;
identifying a respective interval between each purchase of each product within the one or more product-type clusters; and
determining the respective IPI likelihood score for each product within the one or more product-type clusters based on: (a) the respective interval between each purchase of each such product and (b) a global purchase interval from other users for other products in a same one of the one or more product-type clusters in which such product is located, where the user does not have a purchase history for such product.

7. The system of claim 1, wherein determining the respective time and the respective duration for the respective re-purchase notification for the user based on the respective IPI likelihood score for each of the one or more candidate products further comprises:
identifying the respective IPI likelihood score for a particular one of the one or more candidate products that is above 25 days;
determining the respective time for the particular one of the one or more candidate products to be during a first time period;
determining the respective duration for the respective re-purchase notification for the particular one of the one or more candidate products to be from day 25 to day 35 since the purchase by the user of the particular one of the one or more candidate products; and
in response to the user not interacting with the candidate products, resetting the respective IPI likelihood score of the particular one of the one or more candidate products to 0.

8. The system of claim 1, wherein ranking the one or more candidate products based on the respective IPI likelihood score for the one or more candidate products further comprises identifying a group of the one or more candidate products with highest ones of the respective IPI likelihood scores.

9. The system of claim 8, wherein the computing instructions, when executed on the one or more processors, further cause the one or more processors to perform transmitting the group of the one or more candidate products to a customer relationship management server.

10. The system of claim 1, wherein the computing instructions, when executed on the one or more processors, further cause the one or more processors to perform:
analyzing interaction data for the user with the GUI, the interaction data including clicks on products within the at least the subset of the one or more candidate products;
resetting the respective IPI likelihood scores for the one or more candidate products within the at least the subset of the one or more candidate products that include interaction data; and
updating the GUI to include a second subset of the one or more candidate products with respective IPI likelihood scores that satisfies a threshold.

11. A method implemented via execution of computing instructions configured to run at one or more processors and configured to be stored at non-transitory computer-readable media, the method comprising:
receiving historical marketplace information for a user in a marketplace corresponding to products previously purchased by the user;
processing the products to group the products into one or more product-type clusters;
analyzing the one or more product-type clusters to determine respective inter-purchase interval (IPI) likelihood scores for each product in each of the one or more product-type clusters;
identifying one or more candidate products from the one or more product-type clusters that have respective IPI likelihood scores that satisfy one or more thresholds;
determining a respective time and a respective duration for a respective re-purchase notification for the user based on the respective IPI likelihood score for each of the one or more candidate products;
ranking the one or more candidate products based on the respective IPI likelihood scores for the one or more candidate products; and
transmitting a re-purchase notification to the user via a graphical user interface (GUI) that includes at least a subset of the one or more candidate products, the GUI including a first section that includes a first portion of the at least the subset of the one or more candidate products and a second section that includes a second portion of the at least the subset of the one or more candidate products.

12. The method of claim 11, wherein the historical marketplace information includes: item attributes of the products, global purchase patterns for the products that are not specific to the user, and product type metadata.

13. The method of claim 11, further comprising, before identifying the one or more candidate products, removing a product from the product-type clusters that does not satisfy a respective one of the one or more thresholds.

14. The method of claim 11, wherein processing the products comprises using a clustering model comprising a clustering algorithm to group the products into the one or more product-type clusters.

15. The method of claim 13, wherein each of the one or more thresholds is more than 40 days.

16. The method of claim 11, wherein analyzing the one or more product-type clusters to determine the respective IPI likelihood scores for each product in each of the one or more product-type clusters further comprises:
analyzing a purchase history for the user for each product within the one or more product-type clusters;
identifying a respective interval between each purchase of each product within the one or more product-type clusters; and
determining the respective IPI likelihood score for each product within the one or more product-type clusters based on: (a) the respective interval between each purchase of each such product and (b) a global purchase interval from other users for other products in a same one of the one or more product-type clusters in which such product is located, where the user does not have a purchase history for such product.

17. The method of claim 11, wherein determining the respective time and the respective duration for the respective re-purchase notification for the user based on the respective IPI likelihood score for each of the one or more candidate products further comprises:
identifying the respective IPI likelihood score for a particular one of the one or more candidate products that is above 25 days;
determining the respective time for the particular one of the one or more candidate products to be during a first time period;
determining the respective duration for the respective re-purchase notification for the particular one of the one or more candidate products to be from day 25 to day 35 since the purchase by the user of the particular one of the one or more candidate products; and
in response to the user not interacting with the candidate products, resetting the respective IPI likelihood score of the particular one of the one or more candidate products to 0.

18. The method of claim 11, wherein ranking the one or more candidate products based on the respective IPI likelihood score for the one or more candidate products further comprises identifying a group of the one or more candidate products with highest ones of the respective IPI likelihood scores.

19. The method of claim 18, further comprising transmitting the group of the one or more candidate products to a customer relationship management server.

20. The method of claim 11, further comprising:
analyzing interaction data for the user with the GUI, the interaction data including clicks on products within the at least the subset of the one or more candidate products;
resetting the respective IPI likelihood scores for the one or more candidate products within the at least the subset of the one or more candidate products that include interaction data; and
updating the GUI to include a second subset of the one or more candidate products with respective IPI likelihood scores that satisfies a threshold.
